(19) United States
(12) Patent Application Publication
(10) Pub. No.: US 2013/0024208 A1
(43) Pub. Date: Jan. 24, 2013

(54) Advanced Multimedia Structured Reporting

(71) Applicant: David J. Vining, Houston, TX (US)

(72) Inventor: David J. Vining, Houston, TX (US)

(73) Assignee: The Board of Regents of The University of Texas System, Austin, TX (US)

(21) Appl. No.: 13/512,157

(22) PCT Filed: Nov. 27, 2010
(86) PCT No.: PCT/US2010/058139

§ 371 Date: Oct. 4, 2012

Related U.S. Application Data
(60) Provisional application No. 61/264,577, filed on Nov. 25, 2009.
(60) Provisional application No. 61/384,599, filed on Sep. 20, 2010.

(51) Int. Cl. G06Q 50/24

(52) U.S. Cl. 705/3

(57) ABSTRACT

Embodiments of methods, systems, and apparatuses for generating a composited multimedia-based report are described. In one embodiment, a method includes capturing a medical image configured to be displayed on a medical image display device. The present methods may be independent of the medical image display, and may be able to capture images from any proprietary medical image viewer. The method may also include capturing description data related to the medical image. Additionally, the method may include processing the medical image and the description data related to the medical image on a data processing device. Also, the method may include storing the medical image and the description data related to the medical image in a data storage device.

The present application claims benefit of priority to U.S. Provisional Application Ser. No. 61/264,577 filed Nov. 25, 2009 and U.S. Provisional Application Ser. No. 61/384,599 filed Sep. 20, 2010, the entire contents of which are hereby incorporated by reference.

### BACKGROUND OF THE INVENTION

1. Field of the Invention

The present invention relates generally to the field of radiology. More particularly, it concerns an apparatus, system and method for advanced multimedia structured reporting incorporating radiological images. The present embodiments may be used in other image-based fields requiring linking of image content with descriptive information—e.g., dermatology, pathology, photography, satellite imagery, military targeting, and the like.

2. Description of Related Art

Radiology reporting typically consists of having an expert radiologist visually inspect an image or a series of images, and then dictate a narrative description of the image findings. The verbal description may be transcribed by a human transcriptionist or speech-to-text computer systems to produce a text report that varies in content, clarity, and style among radiologists (Sobel et al., 1996). Although the American College of Radiology publishes a guideline for communication of diagnostic imaging findings, this guideline does not specify a universal reporting format (American College of Radiology, 2005).

Structured reporting (SR) is being advocated by professional organizations such as the Radiological Society of North America to organize image findings and associated information content into searchable databases (Kahn et al., 2009; Reiner et al., 2007). The advantage of SR is that it may facilitate applications such as data mining, disease tracking, and utilization management. Many SR solutions have been proposed but universal adoption is hindered by two major challenges. First, most SR solutions try to alter the way that a radiologist naturally practices. For example, some SR solutions require that a radiologist complete a predefined reporting template or point-and-click on an image with a computer mouse; however, the natural workflow of a radiologist is to look at images followed by dictation of verbal descriptions of image findings that may occur sometime after the initial observations. Second, the various image display systems used by radiologists are proprietary commercial products subject to FDA regulations, and although SR standards are being proposed, requesting that vendors adopt and implement these standards for SR is a major integration and business challenge.

Prior SR solutions have several deficiencies. One such deficiency is the need for software integration with proprietary commercial image display systems (e.g., picture archiving and communication systems, or PACS) and other information systems (e.g., radiology information systems (RIS) and/or electronic medical records, EMR). Another deficiency of current methods is the repetitive mouse motion and clicking upon image findings by a radiologist that could lead to human fatigue and carpal tunnel syndrome. Still another deficiency is the distraction of the radiologists as they are required to look away from an image display screen to a report generation screen to label image findings with terms from a cascading set of pull-down menus or from voice recognition with restricted speech patterns. Also, current methods often include tedious process of linking or connecting image findings across a series of structured reports, a process that is difficult with text-based reporting and requires significant user interaction even with computer-based reporting schemes.

### SUMMARY OF THE INVENTION

Embodiments of methods for generating a multimedia-based structured report are described. In one embodiment, a method includes capturing a medical image configured to be displayed on a medical image display device. The method may also include capturing description data related to the medical image. Additionally, the method may include processing the medical image and the description data related to the medical image on a data processing device. Also, the method may include storing the medical image and the description data related to the medical image in a data storage device.

Additionally, a method may include creating a data association between the medical image and the description data related to the medical image within the data storage device. For example, an embodiment may include linking the medical image to a patient identifier. Also, an embodiment of the method may include linking the medical image to one or more linkable medical images. In one embodiment, the medical image and the linkable medical images may be linked according to a common exam. In another embodiment, the medical image and the linkable medical images from different exams may be linked according to a linking criteria. Additionally, the medical image may be linked to a billing code. One of ordinary skill in the art will recognize other data that may be advantageously linked to the medical image according to the present embodiments.

In one embodiment, the method may also include generating a composited medical report which includes the medical image. The composited medical report may also include at least one of the linkable medical images linked to the medical image. In one embodiment, the medical image and each of the linkable medical images comprises an entire radiological history of a patient. In further embodiments, test results, lab work results, clinical history, and the like may also be represented on the report. In one embodiment, the composited medical report is arranged in a table. The table may include the medical image and at least a portion of the description data related to the medical image. In another embodiment, the composited medical report may be a graphical report that includes a homunculus. In another embodiment, the composited medical report may be a timeline. The timeline may similarly include the medical image and at least one of the linkable medical images.

In one embodiment, the medical image display device comprises a Picture Archiving and Communication System (PACS).

In one embodiment, the description data may include voice data, video data, text, and the like. Additionally, the description data may include eye tracking data. The eye tracking date may include one or more eye-gaze locations, and one or more eye-gaze dwell times. Additionally, the description date may include at least one of a pointer position and a pointer click.

Processing the medical image may include automatically cropping the captured medical image to isolate a diagnostic image component. The cropped image may be included in the composited medical report. In a further embodiment, processing the medical image may include extracting text information from the medical image with an Optical Character Recognition (OCR) utility and storing the extracted text in association with the medial image in the data storage device. Additionally processing may include displaying a graphical user interface having a representation of the image and a representation of the description data, and receiving user commands for linking the image with the description data. For example, the graphical user interface may include a timeline. Also, processing the image the description data on the server may include automatically linking the image with the description data in response at least one of an eye-gaze location and an eye-gaze dwell time. For example, an embodiment may include automatically triggering an image capture in response to an eye-gaze dwell time at a particular eye-gaze location reaching a threshold value.

In one embodiment, the method may include displaying a semitransparent pop-up window displaying prior exam findings associated with a feature of the medical image.

In a further embodiment, processing the medical image may include running an image matching algorithm on the medical image to generate a unique digital signature associated with the medical image. Processing the medical image may also include quantifying a feature of the medical image with an automatic quantification tool.

Processing the medical image may also include automatically tracking a disease progression in response to a plurality of the linkable medical images linked to the medical image description data associated with the one or more linkable images. In one embodiment, processing includes automatically calculating a Response Evaluation Criteria in Solid Tumors (RECIST) value in response to the medical image and the description data related to the medical image. Processing may also include automatically determining a disease stage in response to a feature of the medical image and description data associated with the medical image.

In one embodiment, the description data associated with the medical image comprises a label associated with the medical image. The label may be associated with a feature of the medical image. In one embodiment, the label may be determined from an isolated voice clip according to a natural language processing algorithm. The label may also be determined from optical character recognition of text appearing on the image. In a further embodiment, the label may be determined from a computer input received from a user.

In a further embodiment, the method may include determining whether a duplicate medical image exists in the data storage device, determining whether duplicate description data associated with the medical image exists in the data storage device, and merging duplicate medical images and duplicate description data.

Embodiments of a tangible computer program product comprising a computer readable medium having instructions that, when executed, cause the computer to perform operations associated with the method steps described above. For example, the operations may include receiving a medical image captured on a medical image display device, receiving description data related to the medical image, processing the medical image and the description data related to the medical image on a data processing device, and storing the medical image and the description data related to the medical image in a data storage device.

Another embodiment of a tangible computer program product comprising a computer readable medium having instructions is described. In one embodiment, the operations executed by the computer may include capturing a medical image on a medical image display device, capturing description data related to the medical image, and communicating the medical image and the description data related to the medical image to a processing device, the processing device configured to process the medical image and the description data related to the medical image on a data processing device, and store the medical image and the description data related to the medical image in a data storage device.

Embodiments of an apparatus for multimedia-based structured reporting are also described. An embodiment of the apparatus may include an interface configured to receive a medical image and description data related to the medical image. Additionally, such an apparatus may include a processing device coupled to the interface, the processing device configured to process the medical image and the description data related to the medical image. The apparatus may also include a data storage interface coupled to the processing device, the data storage interface configured to store the medical image and the description data related to the medical image.

In various embodiments, the apparatus may include one or more software defined modules configured to perform operations in response to the instructions stored the tangible computer program product configured to cause the apparatus to carry out operations as described according the above method.

Another embodiment of an apparatus may include a medical image display device configured to display a medical image. This embodiment may also include an image capture utility coupled to the medical image display device, the image capture utility configured to capture the medical image. Additionally, the apparatus may include a user interface device configured to collect description data from a user. In one embodiment, the apparatus may also include a communication adapter coupled to the image capture device and the user interface device, the communication adapter configured to communicate the medical image and the description data related to the medical image to a processing device, the processing device configured to process the medical image and the description data related to the medical image on a data processing device, and store the medical image and the description data related to the medical image in a data storage device.

In one embodiment, the image capture device may include a computer coupled to the display device, the computer having an operating system equipped with a screen capture function. In one embodiment, the medical image display device may be a Picture Archiving and Communication System (PACS). For example, the PACS may be a proprietary system. One advantage of the present embodiments is that the image capture device may capture the medical image from a proprietary medical image display, without requiring direct integration with the proprietary medical image display. In this regard, the present embodiments may be ubiquitous, in that it can be used with any proprietary system, without directly integrating with the proprietary system. This benefit greatly reduced the cost and complexity of the present embodiments, and provides for a more uniform and standardized reporting platform.

In one embodiment, the user interface device may include an eye-tracking device. The user interface device may be a video camera. In another embodiment, the user interface device may be a voice recording device. For example, the voice recording device may be a dictation device having a trigger component.

In further embodiments, the apparatus may include one or more software defined modules configured to perform operations in response to a instructions stored the tangible computer program product. In such an embodiment, operations may include capturing a medical image on a medical image display device, capturing description data related to the medical image, and communicating the medical image and the description data related to the medical image to a processing device, the processing device configured to process the medical image and the description data related to the medical image on a data processing device, and store the medical image and the description data related to the medical image in a data storage device.

Embodiments of a system are also presented. An embodiment, may include a server, a data storage device, and a medical image viewer. In one embodiment, the server may include an interface configured to receive a medical image and description data related to the medical image. The server may also include a processing device coupled to the interface, the processing device configured to process the medical image and the description data related to the medical image. The server may additionally include a data storage interface coupled to the processing device, the data storage interface configured to store the medical image and the description data related to the medical image.

The data storage device may be coupled to the data storage interface. In one embodiment, the data storage device may be configured to receive and store the medical image and the description data related to the medical image.

In one embodiment, the medical image viewer may be coupled to at least one of the server and the data storage device. The medical image viewer may include a medical image display device configured to display a medical image. The medical image viewer may also include an image capture utility coupled to the medical image display device, the image capture utility configured to capture the medical image. For example, the image capture utility may include a screen capture function of a Microsoft Windows® operating system. The medical image viewer may also include a user interface device configured to collect description data from a user. Additionally, the medial image viewer may include a communication adapter coupled to the image capture device and the user interface device, the communication adapter configured to communicate the medical image and the description data related to the medical image to the server.

In various embodiments, the system may include one or more software defined modules configured to perform operations according to embodiments of the method described above.

In one embodiment, the system may include an X-ray machine. The medical imaging device may be a Computed Tomography (CT) scanner. The medical imaging device may be a Magnetic Resonance Imaging (MRI) machine. Alternatively, the medical imaging device may be an ultrasound imaging device. One of ordinary skill in the art will recognize a variety of medical imaging devices that may be used in conjunction with the present embodiments of the apparatuses, systems, and methods.

In one embodiment, the system may include a PACS server configured to receive DICOM data representing the medical image. The system may also include a PACS data storage device coupled to the PACS server, the PACS data storage device configured to store image data representing the medical image.

The system may also include a report viewer configured to receive a media-based report generated by the server in response to the medical image and the description data related to the medical image, the media-based report comprising an entire radiological history of a patient in a single graphical view.

The term “coupled” is defined as connected, although not necessarily directly, and not necessarily mechanically.

The term “linked” is defined as connected by or through an intermediary component forming a relationship. For example, linked tables may have metadata linking one group of data to another group of data, where the metadata creates a logical relationship. Also, two computers may be linked by a cable.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present embodiments. The embodiments may be better understood by reference to one or more of these drawings in combination with the detailed description of specific embodiments presented herein.

FIG. 1 is a schematic block diagram illustrating one embodiment of a system for advance multimedia structured reporting.

FIG. 2 is a schematic block diagram illustrating one embodiment of a medical image viewer system.

FIG. 3 is a schematic block diagram illustrating one embodiment of a computer system.

FIG. 4 is a schematic block diagram illustrating one embodiment of a client for advance multimedia structured reporting.

FIG. 5 is a schematic block diagram illustrating one embodiment of in advance multimedia report server.

FIG. 6 is a schematic block diagram illustrating another embodiment of advance multimedia report server.

FIG. 7 is a schematic flowchart diagram illustrating one embodiment of a method for advance multimedia structured reporting.

FIG. 8 is a schematic flowchart diagram illustrating another embodiment of a method for advance multimedia structured reporting.

FIG. 9 is a perspective view drawing of one embodiment of a voice capture device.

FIG. 10 is a logical view of one embodiment of a method for automatically cropping a medical image for use in a composited medical report.

FIG. 11 is a logical view of one embodiment of a method for generating a composited medical report.

FIG. 12 is a logical view of one embodiment of a method of capturing a medical image and storing the medical image for use in a composited report.

FIG. 13 is a logical view of one embodiment of a method of linking medical images and findings to form a composited medical report.

FIG. 14 is a screen-shot view of one embodiment of a list view composited medical report.

FIG. 15 is a screen-shot view of one embodiment of a homunculus view of a composited medical report.

FIG. 16 is a screen-shot view of another embodiment of a homunculus view of a composited medical report.

FIG. 17 is a logical view illustrating further embodiments of a composited report which includes a timeline and image metrics.

FIG. 18A is a graph diagram of one embodiment of a RECIST result.

FIG. 18B is a graph diagram of one embodiment of a RECIST percent change result.

FIG. 19 is a screen-shot view of one embodiment of a graphical RECIST result including images captured according to the present embodiments.

FIG. 20A is a screen-shot view of one embodiment of a list view report having a finding that has been marked urgent.

FIG. 20B is a front view of a mobile device having an application for receiving urgent notifications corresponding to the urgent finding illustrated in FIG. 20A.

FIG. 21A is a schematic block diagram of one embodiment of an eye tracking system adapted for use with the present embodiments.

FIG. 21B is a representation of an image and associated eye tracking data.

FIG. 21C is a logical representation of an embodiment of a method for associating captured medical images with labels derived through natural language processing from an isolated voice clip.

### DESCRIPTION OF THE ILLUSTRATIVE EMBODIMENTS

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system. Alan Freedman, “The Computer Glossary” 268 (8th ed. 1998). A module comprises a machine or machines executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

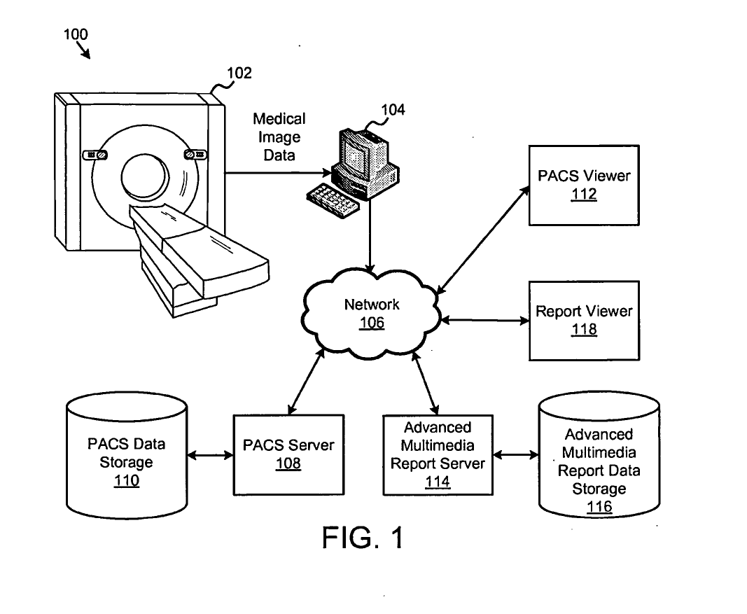

FIG. 1 illustrates one embodiment of a system 100 for advanced multimedia structured reporting. The system 100 may include a server 114, a data storage device 116, and a medical image viewer 112. In additional embodiments, the system 100 may include a medical imaging device 102 and a medical image processing device 104. The medical imaging device 102 may generate medical image data and communicate the medical image data to the medical image processing device 104 for further processing. In particular embodiments, the medical image data may be formatted according to a proprietary formatting scheme, or an industry standard formatting scheme, such as Digital Imaging and Communications in Medicine (DICOM). One of ordinary skill in the art will recognize a variety of formatting schemes that may be used in conjunction with the present embodiments.

In one embodiment, where the system 100 includes a PACS 112, the system 100 may also include a PACS server 108 configured to receive image data representing the medical image. The system 100 may also include a PACS data storage device 110 coupled to the PACS server 108, the PACS data storage device 110 configured to store image data representing the medical image. In one embodiment, each of the various components of the system 100 may be coupled together by a network 106. For example, the network 106 may include, either alone or in various combinations, a Local Area Network (LAN), a Wide Area Network (WAN), a Storage Area Network (SAN), a Personal Area Network (PAN), and the Internet.

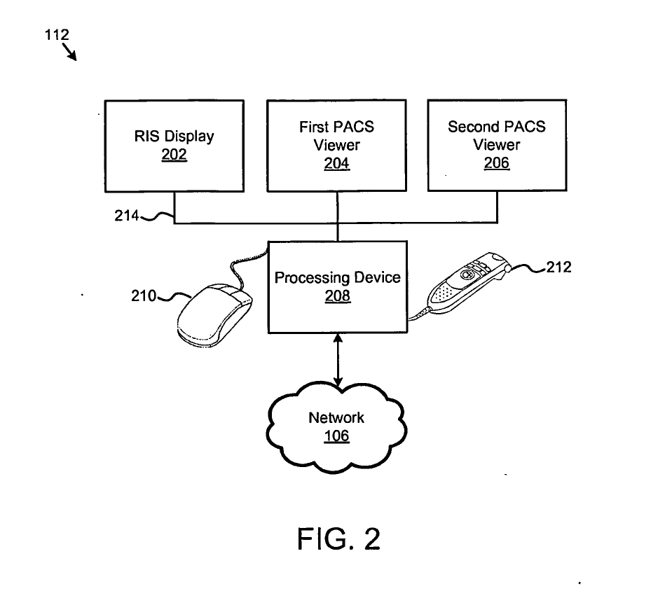

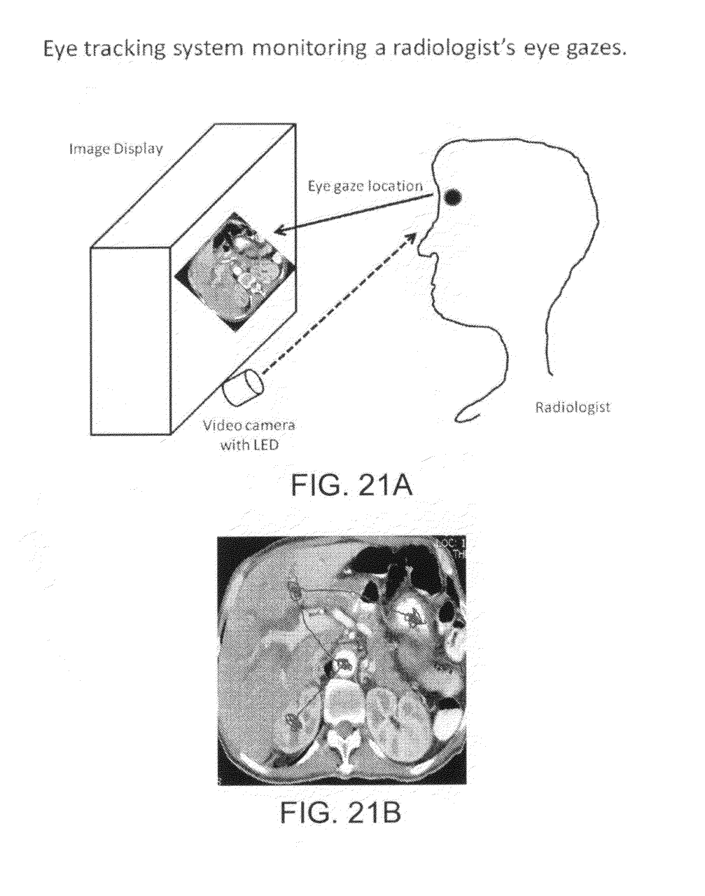

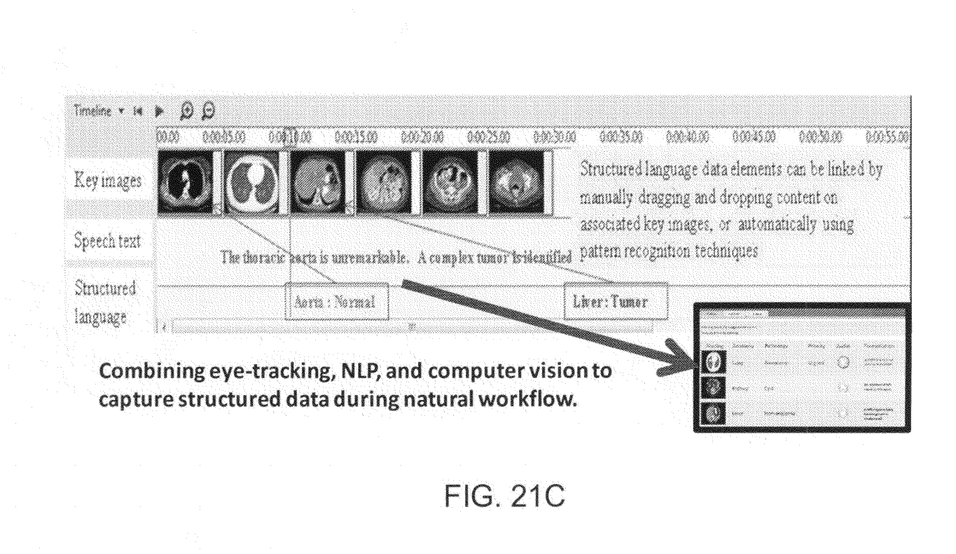

In one embodiment, the medical image viewer 112 may be coupled to at least one of the server 114 and the data storage device 116. The medical image viewer 112 may include a medical image display device 112 configured to display a medical image. For example, FIG. 2 illustrates one embodiment of a medical image viewer 112. In one embodiment, the medical image viewer 112 may include a first PACS viewer 204, a second PACS viewer 206, an RIS display 202, and a processing device 208. The medical image viewer 112 may also include one or more user interface devices, including a mouse pointer 210, a voice recording device 212, a video capture device, such as a video camera or web camera (not shown), an eye tracking device, as illustrated in FIG. 21A, or the like. The user interface devices may collect image description data from a user. For example, a radiologist may view a radiological image on the first PACS viewer 204 and dictate his findings on a speech recording device 212.

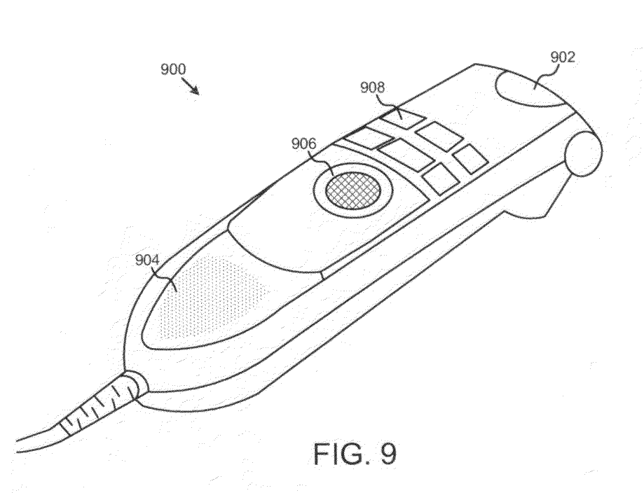

FIG. 9 illustrates one embodiment of a speech recording device 212 that may be used according to the present embodiments. In particular, the speech recording device may include a microphone 1202 for recording voice data, a speaker 1204 for playing back a voice clip, a trigger button 1206 for interfacing the PACS, the client 400, and/or the processing device 208.

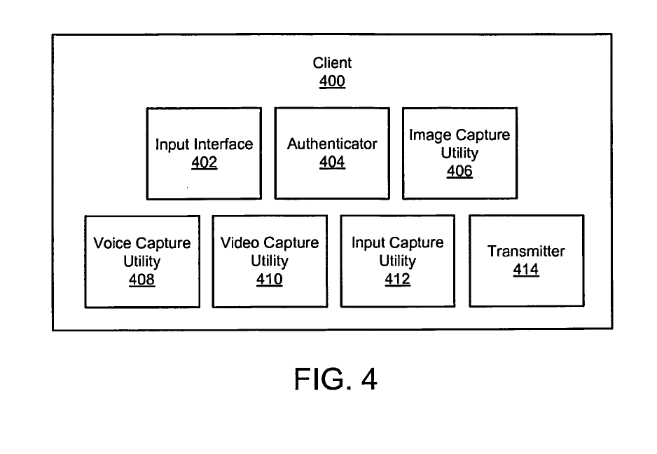

The medical image viewer 112 may also include a processing device 208, such as a computer. An image capture utility 406, as described further in FIG. 4 may be coupled to the medical image display device 112. For example, the image capture utility 406 may be a software client 400 configured to run on the processing device 208 and configured to capture the medical image from the at least one of the first PACS viewer 204 and the second PACS viewer 206. An embodiment of a client 400 is illustrated in FIG. 4. Alternatively, the image capture utility 406 may be a separate device or computer configured to interface with the medical image viewer 112 and to capture either the medical image or a copy of the medical image. In one embodiment, the image capture utility 406 may include a screen capture function of a Microsoft Windows® operating system of the processing device 208 or another computer coupled to the medical image viewer 112. One benefit of such embodiments, is that the client 400 need not be installed or integrated directly with the PACS viewers 204, 206. Accordingly, the present embodiments, may be used to capture images from any medial image viewer, regardless of manufacturer, model, or proprietary requirements. Thus, the present embodiments may be platform independent.

Additionally, the medical image viewer 112 may include a communication adapter 314 coupled to the image capture utility 406 and the user interface device 212, the communication adapter 314 may communicate the medical image and the description data related to the medical image to the server 114.

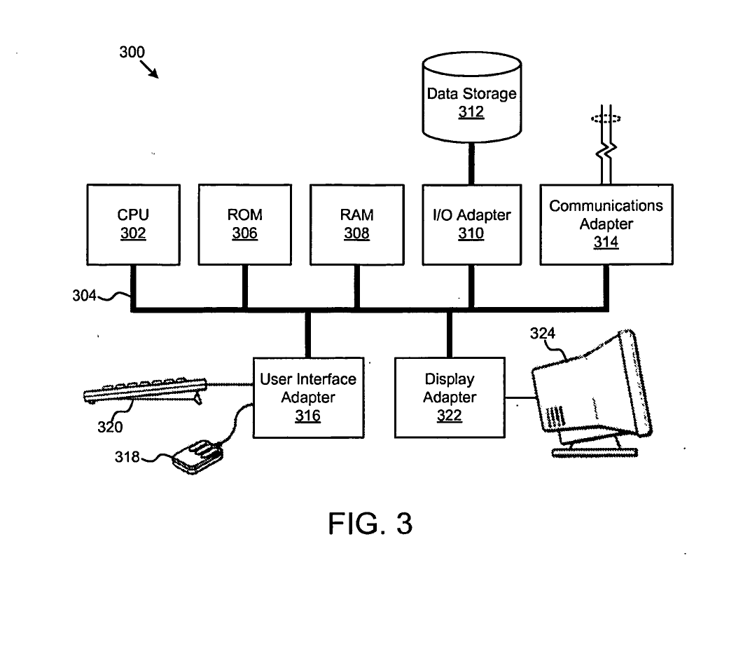

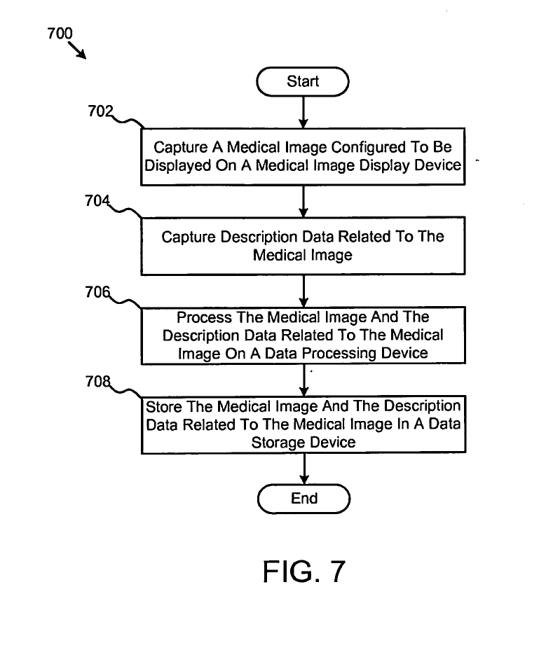

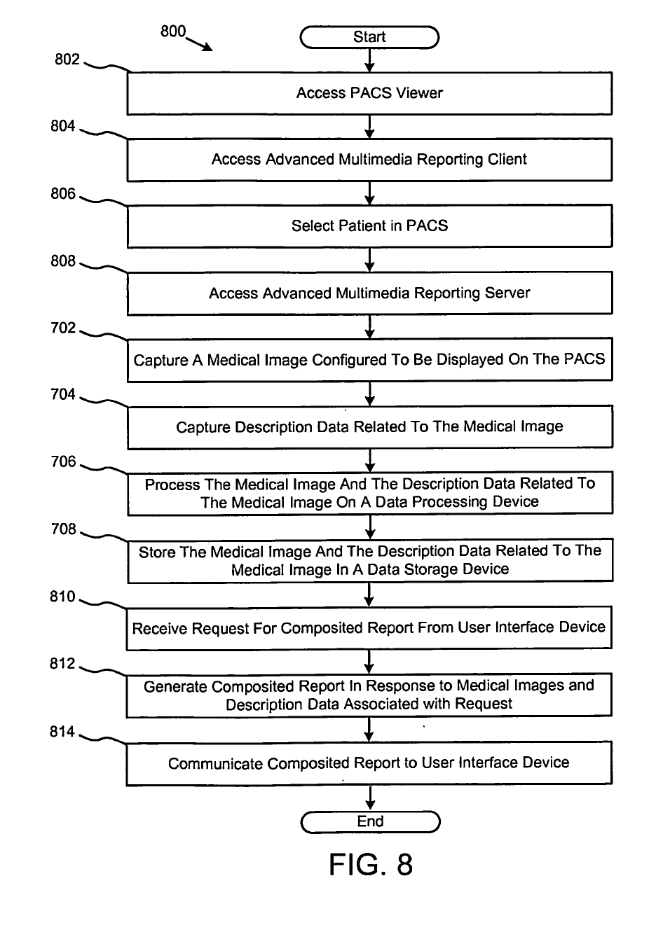

FIG. 3 illustrates a computer system 300 adapted according to certain embodiments of the various servers 108, 114, the processing device 208, and/or the report viewer 118 according to the present embodiments. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIGS. 7 and 8.

The computer system 300 also may include Random Access Memory (RAM) 308, which may be SRAM, DRAM, SDRAM, or the like. The computer system 300 may utilize RAM 308 to store the various data structures used by a software application configured to generate a composited report of a patient's medical history. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information for entering description data related to the medical image and other findings associated with an exam. In a further embodiment, the display adapter 322 may display a graphical user interface associated with a software or web-based application for transferring metrics, classifying images, and the like.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), tablet computers, computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

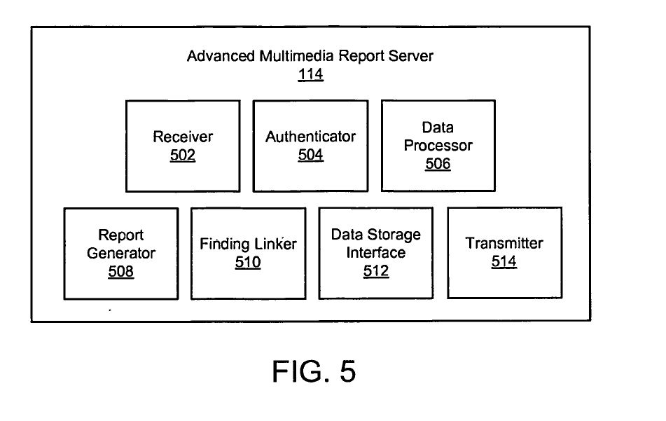

In various embodiments, such as those shown in FIG. 5, the server 114 may include an interface, such as receiver 502, configured to receive a medical image and description data related to the medical image. The server 114 may also include a data processor 506 coupled to the receiver 502, the data processor 506 may be configured to process the medical image and the description data related to the medical image. The server 114 may additionally include a data storage interface 512 coupled to the data processor 506. The data storage interface 512 may be configured to store the medical image and the description data related to the medical image in a data storage device 116.

The data storage device 116 may be coupled to the data storage interface 512. In one embodiment, the data storage device 116 may be configured to receive and store the medical image and the description data related to the medical image. For example, the data storage device 116 may include one or more data storage media configured according to a database schema. The database may be configured to store the medical images and description data according to a logical data association. For example, multiple medical images may be linked, either according to a common exam, or according to another linking criteria. For example, multiple images may be linked if they are taken from the same exam data. These images may be linked to image findings recorded by a medical professional, such as a radiologist. In a further embodiment, images and description data from a first exam may be linked to images and description data from a second exam. For example, linking of this type may be used for disease progression analysis, RECIST calculations, and the like.

In one embodiment, the system 100 may include a medical imaging device 102. For example, the medical imaging device may be an X-ray machine. The medical imaging device may be a Computed Tomography (CT) scanner. The medical imaging device may be a Radio Frequency (RF) imaging device. The medical imaging device may be a Magnetic Resonance Imaging (MRI) machine. Alternatively, the medical imaging device may be an ultrasound imaging device. One of ordinary skill in the art will recognize a variety of medical imaging devices that may be used in conjunction with the present embodiments of the apparatuses, systems, and methods.

The system 100 may also include a report viewer 118 configured to receive a media-based report generated by the server 114 in response to the medical image and the description data related to the medical image, the media-based report comprising an entire radiological history of a patient in a single graphical view. In a particular embodiment, the report viewer may be, for example, a tablet computer. The tablet computer may be configured to run a reporting application. For example, the reporting application may be a web-based application accessible to the report viewer by logging on to the server 114 over the internet. Alternatively, the reporting application may be installed on the report viewer 118 as a native application. In various embodiments, the report viewer may be a desktop computer, a laptop computer, a tablet computer, or a PDA. One of ordinary skill in the art will recognize a variety of suitable hardware platforms configurable as a report viewer 118.

In one embodiment, the system 100 may include a client-server configuration. For example, the client 400 as described in FIG. 4 may be installed on processing device 208. In such an embodiment, the client 400 may include an input interface 402, an authentication module 404, an image capture utility 406, and a transmitter 414. Additionally, the client 400 may include at least one of a voice capture utility 408, a video capture utility 410, and an input capture utility 412.

The server 114 may be configured according to the embodiment described in FIG. 5. For example, the server 114 may include a receiver 502, an authentication module 504, a data processor 506, a report generator 508, a finding linker 510, a data storage interface 512, and a transmitter 514.

In one embodiment, a patient may receive an exam from a CT scanner 102 as illustrated in FIG. 1. The image data from the CT scan may be communicated to a image processing device 104. The image processing device 104 may then communicate the image data to a PACS server 108 over a network 106. The PACS server 108 may then store the image data in a PACS data storage device 110.

A medical professional, such as a radiologist, may then access a PACS viewer 112. The radiologist may then log on to the client 400 by sending authentication credentials, such as a user name and password, to the authentication module 404 of the client 400. The radiologist may also log on to the advanced multimedia server 114 by sending authentication credentials to the authentication module 504 of the server 114.

The radiologist may access a patient record on the RIS display 202, and request the image data from the PACS server 108. The PACS server 108 may then communicate the image data over the network 106 to the first PACS viewer 204. The radiologist may then capture a copy of the medical image displayed on the first PACS viewer 112 using the image capture utility 406. For example, the radiologist may click a trigger or function button integrated on the voice recording device 212. The radiologist may also record voice information and other description data regarding the medical image using the mouse pointer 210, a voice recording device 212, a video capture device (not shown) or the like, which may be captured by the input capture utility 412, the voice capture utility 408, and the video capture utility 410 respectively.

The client 400 may then communicate the medical image and the description data to the server 114 by way of the transmitter 414. The receiver 502 on the server 114 may receive the medical image and the description data. If further processing is required, the data processor 506 may then automatically process the medical image and the description data. The medical image and description data may also be linked to other findings by the finding linker 510. The data storage interface 512 may store the medical image and the description data in a data storage device 116. The medical images and description data may be linked by a patient identifier, test number, record number, or the like.

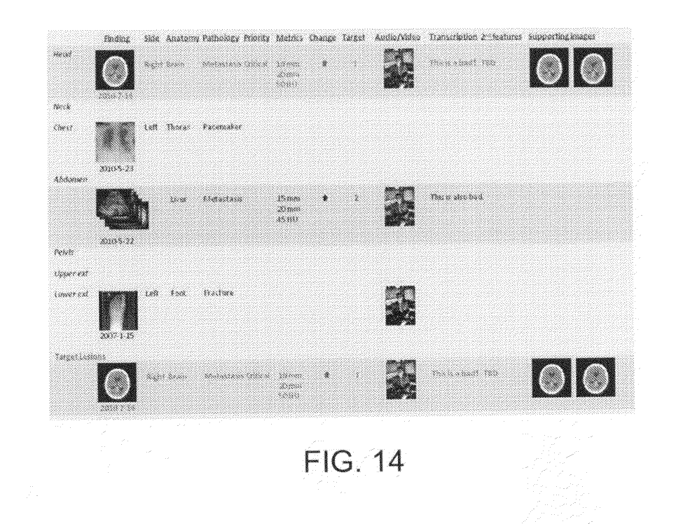

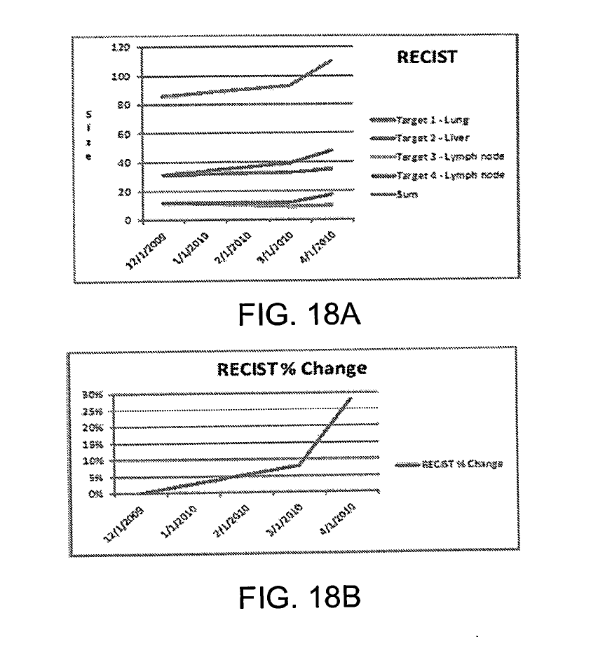

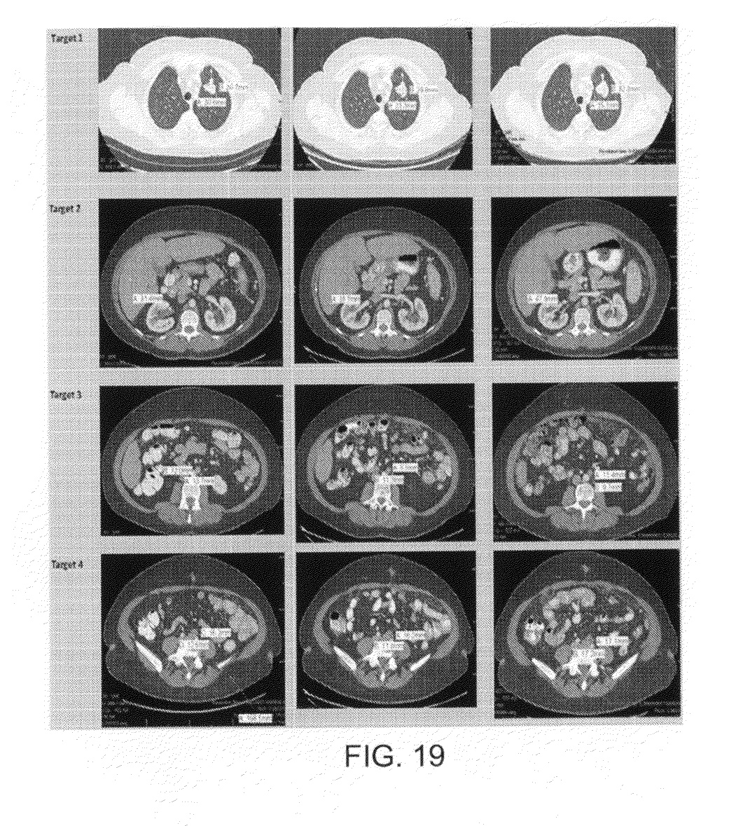

A user may then request a composited medical report from the server 114 using the report viewer 118. The receiver 502 may receive the report request. For example, in one embodiment, the receiver 502 may receive a web request from the report viewer 118 accessing the server 114 over the Internet 106. The report generator 508 may then generate a database request or query according to the parameters of the report request. Parameters may include patient identification information, linking parameters, and the like. The data storage interface 512 may then retrieve the requested information from the data storage device. The report generator may then generate a composited medical report. The report may be either a list view report as illustrated in FIG. 14 or a homunculus style report as illustrated in FIGS. 18-19. The transmitter 514 may then transmit the report over the Internet 106 to the report viewer 118 for rendering.

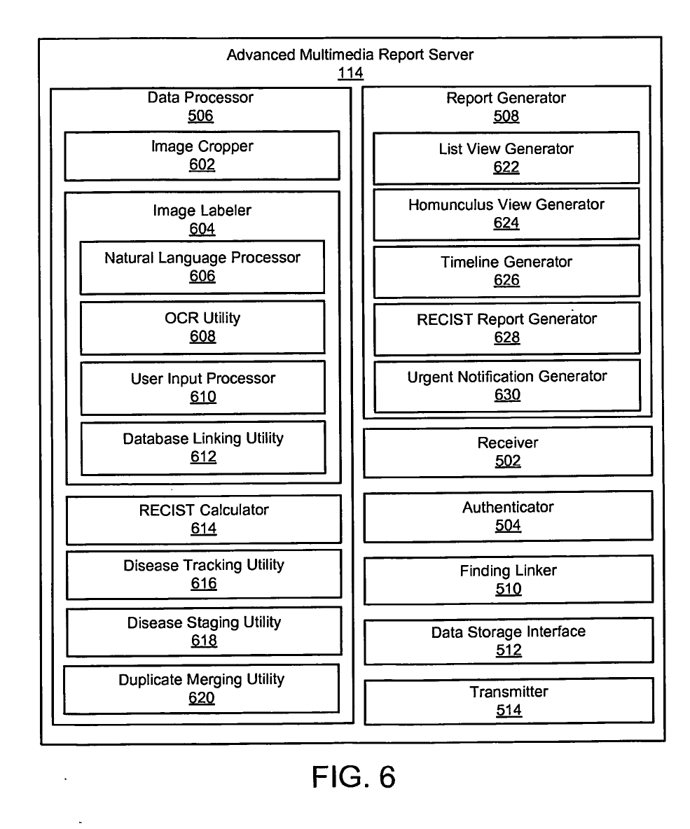

FIG. 6 illustrates a further embodiment of the server 114. As described above with reference to FIG. 5, the server 114 may include a receiver 502, an authenticator module 504, a data processor 506, a report generator 508, a finding linker 510, a data storage interface 512, and a transmitter 514.

In one embodiment, the finding linker 510 may create a data association between the medical image and the description data related to the medical image within the data storage device 116. For example, the finding linker 510 may link the medical image to a patient identifier. Also, the finding linker may link the medical image to one or more linkable medical images. In one embodiment, the medical image and the linkable medical images may be linked according to a common exam. In another embodiment, the medical image and the linkable medical images from different exams may be linked according to a linking criteria. Additionally, the medical image may be linked to a billing code. One of ordinary skill in the art will recognize other data that may be advantageously linked to the medical image according to the present embodiments.

In a further embodiment, the data processor 506 may include an image cropper 602, an image labeler 604, a RECIST calculator 614, a disease tracking utility 616, a disease staging utility 618, and a duplicate merging utility 620. In one embodiment, the data processor 506 may be a CPU 302 as described in FIG. 3. The data processor 506 may be coupled to the receiver 502. The data processor 506 may generally process the medical image and the description data related to the medical image.

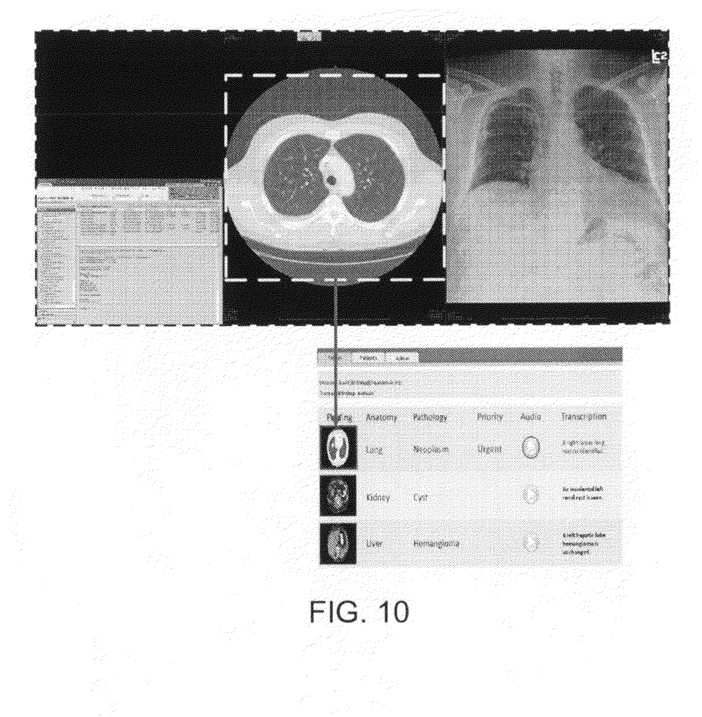

For example, the data processor 506 may include an image cropper 602. The image cropper 602 may automatically crop the medical image to isolate a diagnostic image components. In an alternative embodiment, the image cropper 602 may be integrated with the client 400. FIG. 10 illustrates one embodiment of the function of the image cropper 602. In one embodiment, the image cropper 602 may use hard-coded image coordinates fro cropping the medical image captured by the image capture utility 406. For example, the Philips® PACS system or BRIT® PACS system may include known pixel coordinate systems. The image cropper 602 may be hard-coded to cut the image down to within a subset of the PACS pixels. Optimal image coordinates may vary depending upon the brand of the PACS or 3D workstation, and on image layout. In another embodiment, a Graphical User Interface (GUI) tool may be provided to allow an administrator to set the croppy coordinates by drawing a rubber-band box for a particular workstation configuration. As illustrated in FIG. 10, the size o the rubber-band box may be adjusted by a user. The cropped image may then be stored in the data storage device for use in a multimedia-based report, such as a composited report.

In one embodiment, the image labeler 604 may include one or more of a natural language processor 606, an Optical Character Recognition (OCR) utility 608, a user input processor 610, or a database linking utility 612. In general, the image labeler 604 may include utilities for adding description data to the images captured by the image capture utility 406. Adding the description data may include collecting new description data from a medical professional, such as a radiologist. In another embodiment, adding the description data may include capturing, transferring, or otherwise obtaining existing description data and associating the description data with the captured medical image.

For example, the image labeler 604 may include a natural language processor 606. FIG. 21C illustrates one embodiment of a method for linking description data captured in an isolated voice clip with a medical image. The natural language processing module 606 solves a common workflow problem for medical professionals. For example, a radiologist may look at a first image and identify a notable feature within the first image. Then, while describing the notable feature, the radiologist may be simultaneously scanning a second image to identify a second notable feature. In one embodiment, the radiologist may record a voice clip using the voice capture utility 408. The natural language processor 606 may then use a common voice recognition program to transcribe the voice to text. The natural language processor 606 may then scan the text to identify metrics describing the feature, or may identify key words and equivalents. For example, some key words may include “stable,” “no change,” “improved,” “worsened,” etc. Additionally, natural language processing may be used to identify and assign anatomy, pathology, and priority features. For example, a radiologist viewing a CT image of a lung may state that “the image includes a neoplasm in the left lung which requires urgent attention.” The natural language processor 606 may identify the key words “lung,” “neoplasm,” and “urgent,” and assign the anatomy, pathology, and priority fields accordingly.

In one embodiment, the image labeler 604 may include an OCR utility 608. The OCR utility 608 may scan a medical image captured by the image capture utility 406 to identify text appearing in the image. In one embodiment, the entire medical image may be scanned. Alternatively, certain areas of interest, known to contain text, may be scanned. In a further embodiment, the text may be enhanced for OCR using image processing. The OCR utility 608 may also automatically determine what text may be assigned to certain description data fields. For example, the OCR utility 608 may automatically identify a patient's name, a medical record number, a data, a time, an image location, and the like. The text determined by the OCR utility 608 may be stored in data storage device 116.

In one embodiment, the image labeler 604 may include a user input processor 610. The user input processor 610 may generate one or more menus allowing a user to select labels to assign to the medical image. For example, the menus may be cascading menus, drop-down box menus, text selection boxes, or the like. In another embodiment, the menu may include one or more text entry fields. For example, one or more metrics defining a size of a feature in the medical image may be assigned using a text entry field. In another embodiment, an anatomy field, a pathology field, a priority field, or the like may be assigned using, for example, a cascading menu of selections. Each selection may populate a next level of the cascading menu, providing a user with an additional set of relevant selections.

In one embodiment, as illustrated in FIGS. 21A-C, the user input processor 610 may receive and process eye tracking data. An embodiment of an eye tracking system is illustrated in FIG. 21A. The user may hold his gaze at a particular location for a particular amount of time. The eye tracking camera may track the eye gaze locations and correlate those locations to a portion of the medical image. For example, FIG. 21B illustrates one embodiment of eye gaze locations determined by the eye tracking device of FIG. 21A. In addition to eye tracking locations, the user input processor 610 may track timing of changes in eye gaze locations as illustrated in FIG. 21C. In a particular embodiment, the user input processor 610 and the natural language processor 606 may work in conjunction to assign labels to feature of the medical image indicated by eye gaze locations. An embodiment of this is illustrated in FIG. 21C. In one embodiment, the voice clip may be isolated from the eye gaze location information collected by the eye tracking device. In such an embodiment, the voice clip may be analyzed by time, and the eye gaze location information may be analyzed by time.

Unlike common eye-tracking technology, the present embodiments include association of information content from the radiologist's verbal descriptions (and the inherent medical importance of that information content) with key images that gives captured images a degree of significance. In a typical work flow of a radiologist, a long dwell time may occur when a radiologist looks at an image finding that is perplexing but ultimately unimportant, whereas the radiologist may spend less time looking at important findings that are more obvious. The linking of information content with key images provides a more accurate means of assigning value to significant images, as compared with prior technologies.

In another embodiment, an separate eye tracking module may be included with the client 400. In a further embodiment, when the user holds his eye gaze location in a particular location for a duration of time that reaches a predetermined threshold, this event may automatically trigger an image capture.

In a further embodiment, the image labeler 604 may include a database linking utility 612. For example, description data related to an original medical image displayed on, for example the first PACS viewer 204 may be stored a PACS data storage device 110. In one embodiment, the description data may be automatically retrieved from the PACS data storage device 110 by the database linking utility 612. In another embodiment, medical images and description data stored within the data storage device 116 may be stored in separate databases based upon, for example, anatomy, modality, or the like. In one embodiment, the database linking utility 612 may link or retrieve information from the multiple databases using an index or key field. For example, all images and description data related to a patent name, patient ID, or the like may be linked and retrieved by the database linking utility 612.

In one embodiment, the RECIST calculator 614 may automatically perform RECIST calculations. For example, FIGS. 18A-21C illustrate sample results of the RECIST calculator 614. In one embodiment, the RECIST calculator 614 may calculate results according to published rules that define when cancer patients improve (“respond”), stay the same (“stabilize”), or worsen (“progression”) during treatments. The RECIST calculator 614 may calculate numerical values based upon tumor metrics contained in the description data. In another embodiment, the RECIST calculator 628 may generate graphs representing tumor response levels or percent change levels as illustrated in FIGS. 18A-B based upon the results calculated by the RECIST calculator 614. In a further embodiment, the RECIST calculator 628 may generate a RECIST report, based upon the RECIST calculations performed by the RECIST calculator 614 that may include linked medical images captured by the image capture utility 406 as illustrated in FIG. 21C.

In various embodiments, the server 114 may also include a disease tracking utility 616 and a disease staging utility 618. The RECIST values generated by the RECIST calculator 614 may be used for disease tracking and disease staging. In a particular embodiment, a disease staging report may be generated by the disease staging utility 618. The disease stages may include Stage 0, Stage 1, Stage 2, Stage 3, Stage 4, and recurrence. For example, if a patient is diagnosed with colon cancer, the stage of the cancer may be automatically determined by the disease staging utility 618 in response to the description data. In this example, stage 0 would indicate that the cancer is found only in the innermost lining of the colon or rectum. Stage 1 would indicate that the tumor has grown into the inner wall of the colon or rectum. The tumor has not grown through the wall. Stage 2 would indicate that the tumor extends more deeply into or through the wall of the colon or rectum, or that it may have invaded nearby tissue, but cancer cells have not spread to the lymph nodes. Stage 3 would indicate that the cancer has spread to nearby lymph nodes, but not to other parts of the body. Stage 4 would indicate that the cancer has spread to other parts of the body, such as the liver or lungs. Recurrence would indicate that this is cancer that has been treated and has returned after a period of time when the cancer could not be detected, and that the disease may return in the colon or rectum, or in another part of the body. The criteria for these stages, and the corresponding stages for other types of cancer have been determined by the US National Institutes of Health. The disease tracking module 616 may use staging information, RECIST information, and other metrics contained in the description data to automatically track the progression of a disease. The disease tracking module 616 may tack the disease in the form of graphs, tables, timelines, or the like.

The duplicate merging utility 620 may merge duplicate findings. Merged findings are useful when a finding is identified on more than one image series (e.g., CT scan with arterial, venous, and delayed phases of imaging). In one embodiment, the merge utility 620 may automatically detect duplicate findings by analyzing a set of features of each medical image. Alternatively, the duplicate merging utility 620 may provide a user interface for allowing a user to manually select duplicate findings for merging.

In one embodiment, the report generator 508 may include a list view generator 622, a homunculus view generator 624, a timeline generator 626, a RECIST report generator 628 and an urgent notification generator 630. In general, the medical images and description data associated with the medical images may be retrieved from a database in the data storage device 116 to generate one or more of a list view report, a homunculus view report, a timeline report, a RECIST report, or the like. In a particular embodiment, the list view report and/or homunculus view report may be composited reports. A composited report may be an aggregate of all image findings, with the most recent image finding from any modality being displayed on specific anatomical locations (in a homunculus-style report) or in anatomical categories (in a list-style report) with indicators showing certain image findings being linked to prior findings (e.g., stacked image appearance). This is distinct from a conventional report which comprises a list of image findings pertaining to a specific modality/date/time/anatomy imaged (e.g., Chest x-ray obtained on a certain date and time). However, from the database of image findings stored on database 116 the findings pertaining to a specific exam may be filtered out to create a subset of findings that are equivalent to a conventional radiology report.

FIG. 14 illustrates one embodiment of a composited list view report. As shown in FIG. 14, the list view report may appear in table form. The list view report may include one or more medical image thumbnails. The report may be organized according to anatomy, pathology, time, or any other criteria specified by a user to the list view report generator 622. In the embodiment of FIG. 14, the list view report includes a finding category, a thumbnail image of a medical image, an indication of orientation, the location within the anatomy, a pathology indicator, a priority indicator, feature metrics, a change indicator, as generated by the disease tracking utility 616, video or audio of the medical professional describing the finding, a textual transcription of the medical professional's findings, and an indicator of additional supporting images. Of course, one of ordinary skill in the art will recognize that more or fewer fields may be included in the list view report.

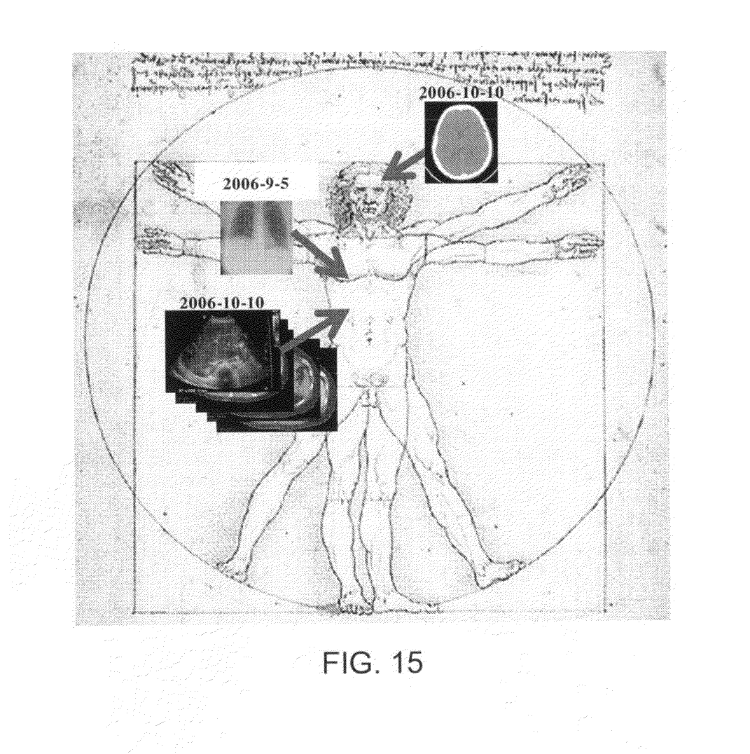

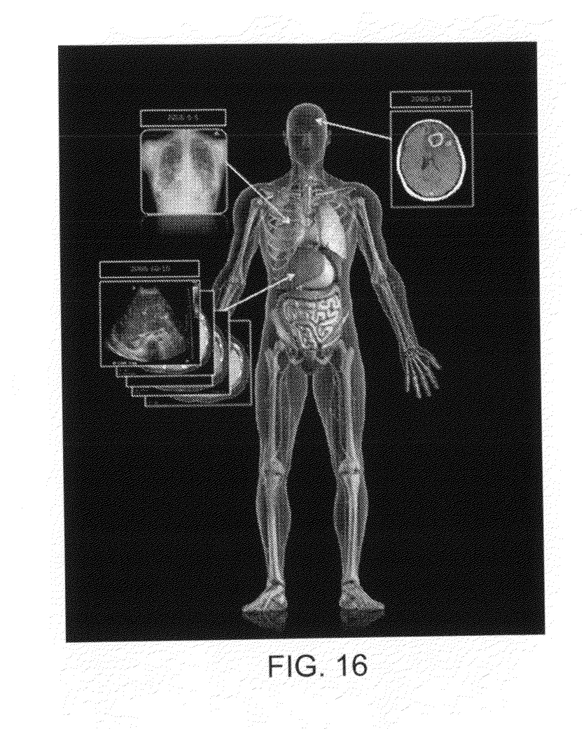

FIG. 15 illustrates one embodiment of a homunculus view report generated by the homunculus view generator 624. FIG. 16 illustrates an alternative embodiment. One of ordinary skill will recognize many different embodiments of a homunculus and homunculus view report. In one embodiment of the homunculus view report of FIGS. 18 and 19, a most recent finding may appear in a location on the homunculus that correlates to physical anatomy of the patient. In one embodiment, if additional findings exist with relation to the anatomy of the most recent fining, an indicator that additional findings exist may appear on the homunculus report. For example, as illustrated in FIGS. 18 and 19, multiple findings may appear as stacked images. Alternatively, a box, star, or other indicator may indicate that additional findings exist. The user may then click on the thumbnail of the finding and additional information about the finding or additional findings may appear, either in a new viewing panel or in the same viewing panel.

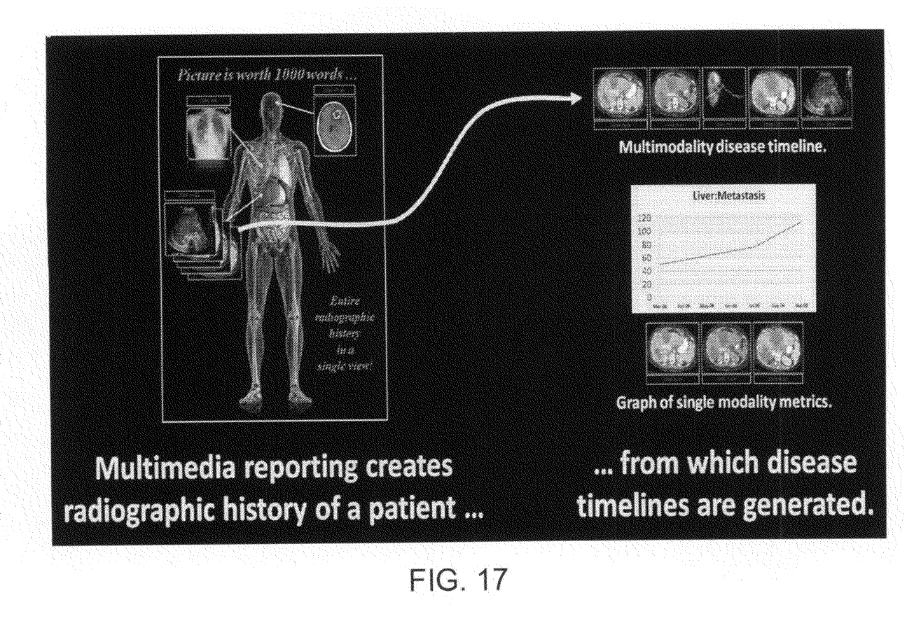

As illustrated in FIG. 17, the timeline generator 626 may generate a timeline of the images. In one embodiment, the timeline generator 626 may generate a disease timeline that includes images and findings from multiple different modalities. For example, a disease timeline may include links to CT findings, ultrasound findings, lab findings, and the like. In one embodiment, the links may include thumbnail images corresponding to the medical images.

Additional information may be included in the detailed view illustrated in FIG. 17. For example, the detailed view may include feature metrics, graphs, RECIST information, disease stage information, disease tracking information, and other information included in the description data.

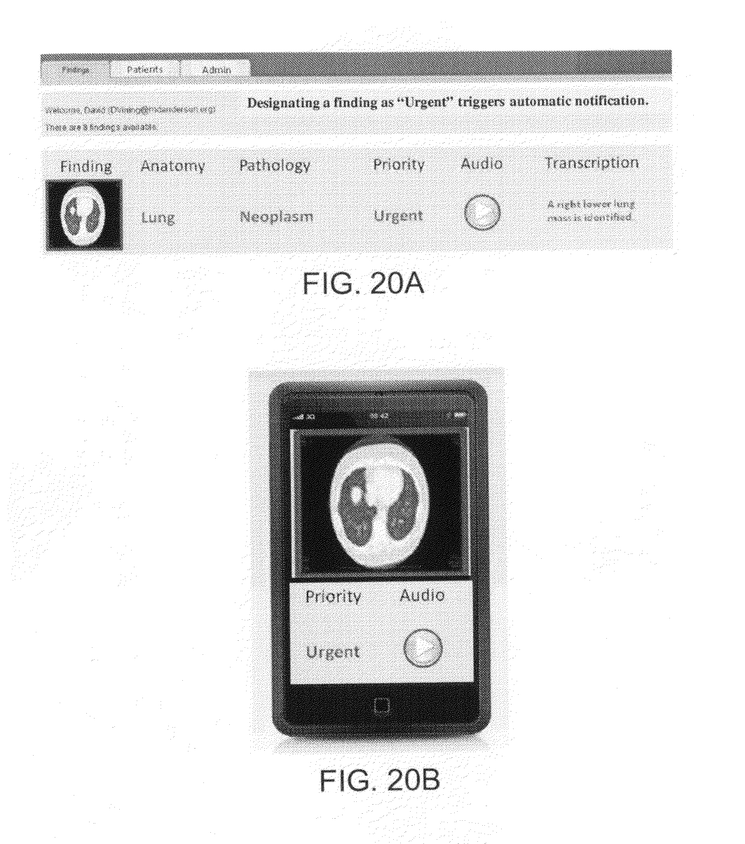

In one embodiment, the report generator 508 may include an urgent notification generator 630. The urgent notification generator 630 may automatically generate a notification, for example, to a medical professional, in response to a determination that a finding has an urgent priority. For example, a radiologist may review an abdominal CT to determine whether a patient has appendicitis and whether the patient's appendix is in danger of bursting. If the radiologist sets the priority field to urgent, urgent notification generator 630 may notify a referring physician, a surgeon, operating room staff, or the like that urgent attention is required. The urgent notification generator 630 may generate an automated telephone call, a page, an email, a text message, or the like. In another embodiment, the urgent notification generator 630 may interface with a mobile application loaded on a mobile device. For example, as illustrated in FIGS. 20A and 20B, when a priority field is set to urgent, a mobile application on a remote mobile device may trigger a notification. In one embodiment, the notification may include a copy of the medical image, an indicator of priority, and a link to listen to audio or view video of the radiologist's findings.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 7 illustrates one embodiment of a method 700 for generating a composited medical report. In one embodiment, the method 700 starts when the image capture utility 406 captures 702 a medical image configured to be displayed on a medical image display device 112. In one embodiment, the image capture utility 406 may copy an image displayed on a commercially available PACS viewer 204. For example, the image capture utility 406 may include a screen capture function. The voice capture utility 408, video capture utility 410, and input capture utility 412 may then capture 704 description data related to the medical image. For example, the voice capture utility 408 may capture a voice clip of a medical professional dictating findings. The video capture utility 410 may include a web-cam (not shown) configured to capture a video recording of a medical professional describing findings. The input capture utility may include eye tracking data, menu selections, text entries, or the like. Additionally, the method 700 may include processing 706 the medical image and the description data related to the medical image on a data processing device, such as on the server 114. In particular, the data processor 506 on the server 114 may process the medical image and description data. Also, the method 700 may include storing 708 the medical image and the description data related to the medical image in a data storage device 116. For example, the data storage interface 512 may store the medical image and the description data in the data storage device 116.

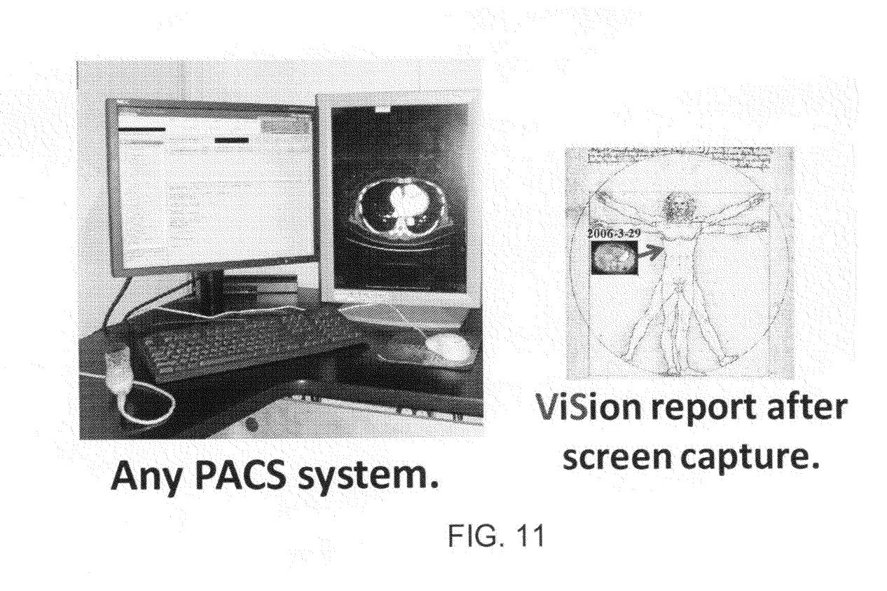

Another embodiment of a method 800 is described in FIG. 8. The method 800 may start when a user accesses 802 a PACS viewer. The user may then access 804 the advanced multimedia reporting client 400. For example, the user may log onto the client 400 by sending credentials to the authentication module 404. The user may then select 806 a patient for viewing on the PACS. For example, the user may select the patient in an RIS system 202. The user may then access 808 the advanced multimedia reporting server 114. The user may then trigger the image capture utility 406 on the client to capture 702 a copy of the image displayed on the PACS viewer 204. This screen capture 702 may work with any image viewing platform, and may not require integration with the PACS viewer. For example, the user may use a trigger or function of a dictation device 212, such as a Philips® Speechmike. Alternatively, the user may trigger the capture with a click of a mouse 210 or a keystroke on a keyboard. Then, one or more of the voice capture utility 408, the video capture utility 410, and the input capture utility 412 may capture description data associated with the medical image. This process is generally illustrated in FIG. 11.

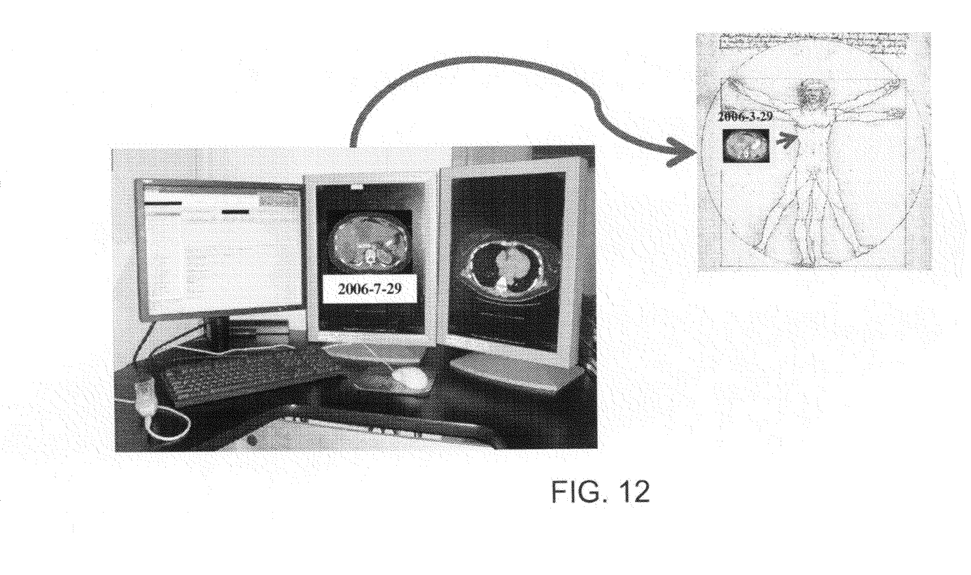

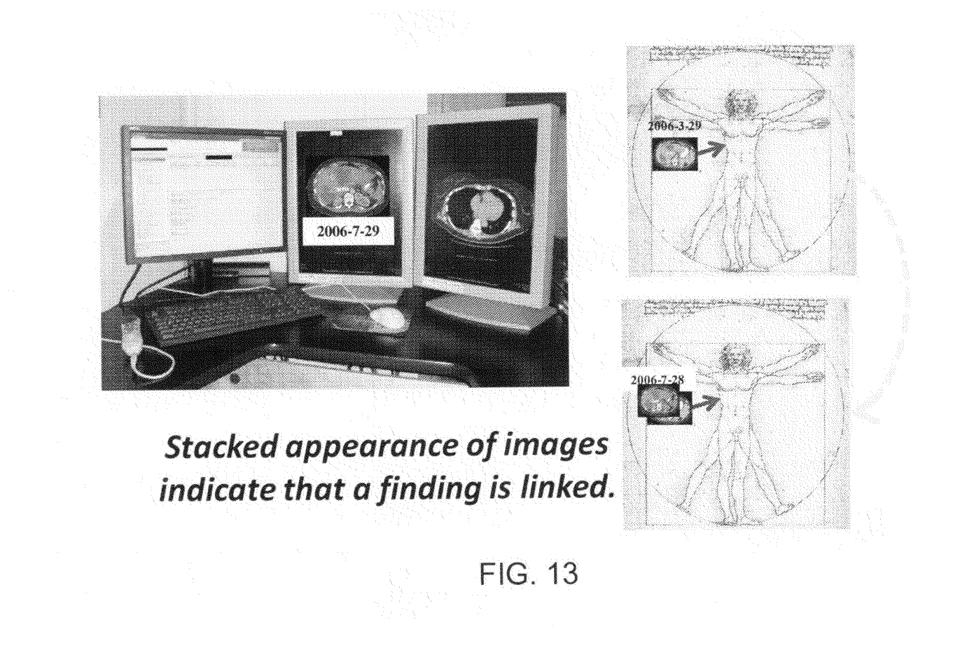

The medical image and the associated description data may be transmitted, using transmitter 414 to the server 114, as shown in FIG. 12. The server 114 may process 706 the medical image and the description data as described in embodiments above. For example, the description data may be further generated or refined by the OCR utility 608, the natural language processor 606 and the user input processor 610. The data storage interface 512 may then store 708 the medical image and the description data related to the medical image in the data storage device 116. In a further embodiment, the finding linker 510 may link the medical image and the description data to other medical images and description data based upon linking fields in a database, or the like. This process is generally described in FIG. 13.

Next, a second user may request a report from the server 114. For example, the second user may send a request for a composited report associated with a selected patient via report viewer 118 to the server 114. The server 114 may receive 810 the request for the composited report and the report generator 508 may generate 812 the composited report by accessing medical images and description data from a database of medical images and description data stored on the data storage device 116. The transmitter 514 may then communicate 814 the composited report over the network 106 to the report viewer 118. The composited report may be either a list view report as illustrated in FIG. 14 or a homunculus view report as illustrated in FIGS. 15-16. In response to a click on an image thumb on the composited report, the report viewer may request additional information about the selected finding from the server 114. The server 114 may query the database stored on the data storage device 116 and return additional report information to the report viewer 118.

In a further embodiment, the method 800 may also include generating a composited medical report which includes the medical image. The composited medical report may also include at least one of the linkable medical images linked to the medical image. In one embodiment, the medical image and each of the linkable medical images comprises an entire radiological history of a patient. In further embodiments, test results, lab work results, clinical history, and the like may also be represented on the report. In one embodiment, the composited medical report is arranged in a table. The table may include the medical image and at least a portion of the description data related to the medical image. In another embodiment, the composited medical report may be a graphical report that includes a homunculus. In another embodiment, the composited medical report may be a timeline. The timeline may similarly include the medical image and at least one of the linkable medical images.

Processing 706 the medical image may include automatically cropping the captured medical image to isolate a diagnostic image component. The cropped image may be included in the composited medical report. In a further embodiment, processing 706 the medical image may include extracting text information from the medical image with an Optical Character Recognition (OCR) utility and storing the extracted text in association with the medial image in the data storage device 116. Additionally processing may include displaying a graphical user interface having a representation of the image and a representation of the description data, and receiving user commands for linking the image with the description data. For example, the graphical user interface may include a timeline. Also, processing the image the description data on the server 114 may include automatically linking the image with the description data in response at least one of an eye-gaze location and an eye-gaze dwell time. For example, an embodiment may include automatically triggering an image capture in response to an eye-gaze dwell time at a particular eye-gaze location reaching a threshold value.

In a further embodiment, processing 706 the medical image may include running an image matching algorithm on the medical image to generate a unique digital signature associated with the medical image. Processing 706 the medical image may also include quantifying a feature of the medical image with an automatic quantification tool.

Processing 706 the medical image may also include automatically tracking a disease progression in response to a plurality of the linkable medical images linked to the medical image description data associated with the one or more linkable images. In one embodiment, processing includes automatically calculating a Response Evaluation Criteria in Solid Tumors (RECIST) value in response to the medical image and the description data related to the medical image. Processing may also include automatically determining a disease stage in response to a feature of the medical image and description data associated with the medical image.

In one embodiment, the description data associated with the medical image comprises a label associated with the medical image. The label may be associated with a feature of the medical image. In one embodiment, the label may be determined from an isolated voice clip according to a natural language processing algorithm. The label may also be determined from optical character recognition of text appearing on the image. In a further embodiment, the label may be determined from a computer input received from a user.

In a further embodiment, the method 700 may include determining whether a duplicate medical image exists in the data storage device 116, determining whether duplicate description data associated with the medical image exists in the data storage device 116, and merging duplicate medical images and duplicate description data.

In one embodiment a tangible computer program product comprising a computer readable medium may include instructions that, when executed, cause a computer, such as server 114 to perform operations associated with the steps of method 700 described above. For example, the operations may include receiving a medical image captured on a medical image display device 112, receiving description data related to the medical image, processing 706 the medical image and the description data related to the medical image on a data processing device, and storing 708 the medical image and the description data related to the medical image in a data storage device 116.

In another embodiment of a tangible computer program product comprising a computer readable medium having instructions, the operations executed by the computer, such as processing device 208 may include capturing 702 a medical image on a medical image display device 112, capturing 704 description data related to the medical image, and communicating the medical image and the description data related to the medical image to a processing device, the processing device configured to process the medical image and the description data related to the medical image on a data processing device, and store the medical image and the description data related to the medical image in a data storage device 116.

All of the devices, systems, and/or methods disclosed and claimed herein can be made and executed without undue experimentation in light of the present disclosure. While the compositions and methods of this invention have been described in terms of some embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims

1. A method comprising:
capturing a medical image configured to be displayed on a medical image display device;
capturing description data related to the medical image;
processing the medical image and the description data related to the medical image on a data processing device; and
storing the medical image and the description data related to the medical image in a data storage device.

2. The method of claim 1, further comprising creating a data association between the medical image and the description data related to the medical image within the data storage device.

3. (canceled)

4. The method of claim 1, further comprising linking the medical image to one or more linkable medical images.

5. The method of claim 1, where the medical image and the linkable medical images are linked according to a common exam.

6. The method of claim 1, where the medical image and the linkable medical images from different exams are linked according to a linking criteria.

7. (canceled)

8. The method of claim 1, further comprising generating a composited medical report, the composited medical report comprising the medical image.

9. The method of claim 1, further comprising generating a composited medical report comprising the medical image and at least one of the linkable medical images linked to the medical image.

10. The method of claim 1, further comprising generating a composited medical report comprising the medical image and each of the linkable medical images comprising an entire radiological history of a patient.

11-12. (canceled)

13. The method of claim 1, where the composited medical report comprises a graphical report comprising a timeline, the timeline comprising the medical image and at least one of the linkable medical images.

14-15. (canceled)

16. The method of claim 1, where the description data comprises voice data.

17. (canceled)

18. The method of claim 1, where the description data comprises text.

19. The method of claim 1, where the description data comprises eye tracking data, the eye tracking data comprising:
one or more eye-gaze locations; and
one or more eye-gaze dwell times.

20. (canceled)

21. The method of claim 1, where processing the medical image comprises automatically cropping the captured medical image to isolate a diagnostic image component.

22. The method of claim 1, where processing the medical image comprises extracting text information from the medical image with an Optical Character Recognition (OCR) utility and storing the extracted text in association with the medial image in the data storage device.

23-25. (canceled)

26. The method of claim 1, comprising automatically triggering an image capture in response to an eye-gaze dwell time at a particular eye-gaze location reaching a threshold value.

27. (canceled)

28. The method of claim 1, where processing the medical image comprises running an image matching algorithm on the medical image to generate a unique digital signature associated with the medical image.

29-31. (canceled)

32. The method of claim 1, where processing the medical image comprises automatically determining a disease stage in response to a feature of the medical image and description data associated with the medical image.

33-34. (canceled)

35. The method of claim 1, comprising determining the label from an isolated voice clip according to a natural language processing algorithm.

36. The method of claim 1, comprising determining the label from optical character recognition of text appearing on the image.

37-79. (canceled)

80. An apparatus comprising;
a medical image display device configured to display a medical image;
an image capture utility coupled to the medical image display device, the image capture utility configured to capture the medical image;
a user interface device configured to collect description data from a user, the user interface device having a dictation device for recording voice, the dictation device having a trigger; and
a communication adapter coupled to the image capture device and the user interface device, the communication adapter configured to communicate the medical image and the description data related to the medical image to a processing device, the processing device configured to process the medical image and the description data related to the medical image on a data processing device, and store the medical image and the description data related to the medical image in a data storage device.

81-96. (canceled)

97. A system comprising:
a server comprising:
an interface configured to receive a medical image and description data related to the medical image;
a processing device coupled to the interface, the processing device configured to process the medical image and the description data related to the medical image; and
a data storage interface coupled to the processing device, the data storage interface configured to store the medical image and the description data related to the medical image;
a data storage device coupled to the data storage interface, the data storage device configured to receive and store the medical image and the description data related to the medical image; and
a medical image viewer coupled to at least one of the server and the data storage device, the medical image viewer comprising:
a medical image display device configured to display a medical image;
an image capture utility coupled to the medical image display device, the image capture utility configured to capture the medical image;
a user interface device configured to collect description data from a user; and
a communication adapter coupled to the image capture device and the user interface device, the communication adapter configured to communicate the medical image and the description data related to the medical image to the server.

98. The system of claim 97, comprising a medical imaging device coupled to the medical image viewer.

99. The system of claim 97, further comprising a report viewer configured to receive a multimedia-based report generated by the server in response to the medical image and the description data related to the medical image, the multimedia-based report comprising an entire radiological history of a patient in a single graphical view.
